(19) United States
(12) Patent Application Publication
(10) Pub. No.: US 2023/0088669 A1
(43) Pub. Date: Mar. 23, 2023

(54) SYSTEM AND METHOD FOR EVALUATING WEIGHT INITIALIZATION FOR NEURAL NETWORK MODELS

(71) Applicant: Cognizant Technology Solutions US Corp., Teaneck, NJ (US)

(72) Inventors: Garrett Bingham, Oakland, CA (US); Risto Miikkulainen, Stanford, CA (US)

(21) Appl. No.: 17/855,955

(22) Filed: Jul. 1, 2022

Related U.S. Application Data
(60) Provisional application No. 63/245,281, filed on Sep. 17, 2021.

(51) Int. Cl. G06N 3/04

(52) U.S. Cl. CPC G06N 3/04

(57) ABSTRACT

The present invention provides a system and a method for evaluating weight initialization techniques for individual layers of neural network model by preserving mean and variance of output signals propagated through respective layers of model. In operation, the present invention provides for deriving a mean-variance mapping function (g-layer) for each layer of received neural network model. Further, the present invention provides for determining if weight parameter is associated with respective layers of model. Furthermore, weight initialization technique is evaluated for setting initial value of weight parameter of layers determined to have weight parameter by using derived mean-variance mapping functions, such that mean of output signal of respective layers is zero and variance is one. The preserving of mean and variance of output signal across respective layers to zero and one respectively ensures that the weight parameter is initialized properly, further eliminating the problem of exploding and/or vanishing output signals.

### CROSS REFERENCE TO RELATED APPLICATIONS

This patent application claims the benefit of U.S. Provisional Ser. No. 63/245,281 filed on Sep. 17, 2021. The referenced application is incorporated by reference herein.

### FIELD OF THE INVENTION

The present invention relates generally to the field of artificial intelligence. More particularly, the present invention relates to a system and a method for evaluating weight initialization for individual layers of deep learning neural network models by preserving mean and variance across output signals propagated through each of the layers, thereby preventing exploding/vanishing output signals from said layers and improving learning performance of the model.

### BACKGROUND OF THE INVENTION

In this era of technology, Artificial Intelligence (AI) has evolved at a great pace with the aim to reduce human effort and simulate human expertise. In order to incorporate artificial intelligence into machines, various machine learning techniques and deep learning techniques have been developed that enable the machines to learn automatically from their previous experiences and data. One such technique which is extensively used to solve complex problems where the data is huge, diverse, and less structured is neural network. As the name suggests, Neural networks, also known as Artificial Neural Networks (ANNs) are inspired by the human brain, and are configured to mimic the biological neurons to recognize patterns from input data and transmit signal to one another.

Most of the Deep learning models today are built on top of Artificial Neural Networks to mimic the human brain. Artificial neural networks (ANNs) are comprised of node layers, including an input layer, one or more hidden layers, and an output layer. The hidden layers may be generally, selected from dense (fully connected) layers, convolutional layers, pooling layers, recurrent layers, normalization layers etc. The hidden layer can range anywhere from 0 to a desired number depending on the complexity of data. Each of the node layers include one or more neurons. The one or more neurons of each node layer connects to one or more neurons of any of the subsequent layers up to the output layer. Mostly, each neuron has an associated weight parameter, bias and an activation function. The assigning of initial values of the weight parameter is referred to as weight initialization. These assigned weights assist in determining the importance of any given variable, with larger ones contributing more significantly to the output compared to other inputs.

Once the weight has been assigned and the input is fed to the input layer, the neuron associated with the input layer performs a linear transformation on the input using the weight parameter and biases, whereby all inputs are multiplied by their respective weights and then summed. Thereafter, the linearly transformed input is passed through an activation function associated with the layer, which determines the output to be passed on to the next layer. In operation, the activation function performs a non-linear transformation on the incoming linearly transformed input to determine an output. For example, in case of a ReLU activation function, if the output exceeds a given threshold associated with the activation function, the connected one or more neurons of the subsequent layer are activated, transmitting data to the next layer in the network. As a result, the non-linear output of one layer becomes the input of the subsequent layer configured to transform the received input linearly. This alternating of the nonlinear activation functions with the linear layers allows neural networks to learn highly complex representations from the input data. However, it has been observed that as the output signal propagates through the network layers, said signal becomes extremely strong and explodes, or becomes extremely weak and vanishes. This behavior of output signal is generally associated with improper weight initialization of the neurons of individual network layers.

Therefore, proper weight initialization is crucial to achieve high performance with a given neural network. While many weight initialization techniques (as discussed in the next few paragraphs) were proposed in the past, these techniques focus on stabilizing signals by accounting for specific components of neural networks, such as specific activation functions, topologies, layer types and training data distribution. Thus, researchers designing new models or activation functions have two of the following options. One option is to derive appropriate weight initialization techniques manually for every neural network architecture considered, which is generally difficult and time consuming. The second option is to use an existing initialization in an incorrect setting, which can be misleading as a candidate neural network model may appear to be inefficient or poor when in fact it is the suboptimal initialization that makes training of the model difficult. A few of the previously proposed initialization techniques are discussed below.

Activation Function-Dependent Initialization: As is common in the literature, fan_in and fan_out refer to the number of connections feeding into and out of a node, respectively. LeCun et al. (2012) recommended sampling of weights from a distribution with mean zero and standard deviation fan_in, whereby propagated signals may have variance approximately one if used with an activation function symmetric about the origin, like 1.7159 tanh((2/3)x) or tanh(x)+ax for some small choice of α. However, it was observed that the standard sigmoid f(x)=1=(1+e^{-x}) induces a mean shift and cannot not be used in this setting. Another weight initialization technique is disclosed vide Glorot and Bengio (2010). This technique is a compromise between two strategies, where one of the strategy aims at ensuring unit variance in the forward-propagated signals and the other strategy aims at ensuring unit variance for the backward-propagated gradients. As a compromise between the two strategies, Glorot and Bengio (2010) discloses initialization of weights by sampling from μ(−√6/ √fan_in+fan_out, √6/ √fan_in+fan_out 6). Further, the disclosed technique works on symmetric functions with unit derivatives at 0, such as tanh or Softsign(x)=x/(1+|x|), and excludes the use of sigmoid function. Yet another technique is disclosed in He et al. (2015). He et al. (2015) introduced the PReLU activation function and a variance-preserving weight initialization to be used with the PReLU function that samples weights from N (0; ·2/fan_in). In yet another effort to initialize weights, Klambauer et al. (2017) introduced SELU, an activation function with self-normalizing properties. These properties are only realized when SELU is used with the initialization scheme proposed in LeCun et al. (2012).

The above described activation function-dependent weight initialization techniques attempt to solve the fundamental problem of scaling weights such that repeated applications of the activation function do not result in vanishing or exploding signals. While these techniques solve the problem in a few special cases as exemplified above, the issue is more general, and therefore manual deriving of correct scaling is required for some of the complicated activation functions. However, deriving the correct scaling is intractable for complicated activation functions.

Topology-Dependent Initialization: The above described activation function dependent initializations are generally for neural networks composed of convolutional or dense layers. Therefore, with introduction of residual networks (ResNets) vide (He et al. 2016b, a), new weight initialization techniques were developed to account for the presence of shortcut connections and various types of residual branches. One such topology dependent initialization is disclosed by Taki (2017). Taki (2017) analyzed signal propagation in plain and batch normalized ResNets, whereby a new weight initialization was developed to stabilize training. However, Taki (2017) did not consider architectural modifications, such as use of deeper residual blocks or reordering components like the activation function or batch normalization layers. Later Zhang, Dauphin, and Ma (2019) introduced “Fixup”, an initialization method that rescales residual branches to stabilize training. Fixup replaces batch normalization in standard and wide residual networks vide (Ioffe and Szegedy 2015; Zagoruyko and Komodakis 2016; He et al. 2016b, a) and replaces layer normalization in Transformer models vide (Vaswani et al. 2017; Ba, Kiros, and Hinton 2016). However, “Fix up” applies only to residual architectures, and needs proper regularization to get optimal performance, and requires additional learnable scalars that slightly increase model size. Arpit, Campos, and Bengio (2019) proposed a new initialization technique for weight-normalized networks vide (Salimansand Kingma 2016) that relies on carefully scaling weights, residual blocks, and stages in the network. However, similar to other techniques, this technique improves performance in specific cases, but imposes design constraints, like requiring ReLU activation functions and a specific Conv→ReLU→Conv block structure.

Layer-Dependent Initialization: Hendrycks and Gimpel (2016a) observed that dropout layers vide Srivastava et al. 2014 affect the variance of forward-propagated signals in a network. Accordingly, it is necessary to take dropout layers and the specific dropout rate into account during weight initialization to stabilize training properly. In fact, pooling, normalization, recurrent, padding, concatenation, and other layer types similarly affect the signal variance. However, none of the current initialization schemes account for type of layers.

Data-Dependent Initialization: Mishkin and Matas (2015) fed data samples through a network, and normalized the output of each layer to have unit variance. KrahenBuhl et al. (2015) adopted a similar approach, but opted to normalize along the channel dimension instead of across an entire layer. Data-dependent weight initializations rely on empirical variance estimates derived from the data in order to be model-agnostic. However, data-dependent weight initializations introduce a computational overhead (Mishkin and Matas 2015), and are not applicable in settings where data is not available or its distribution may shift over time such as online learning or reinforcement learning. The quality of the initialization is also dependent on the number of the data samples chosen, and suffers when the network is very deep (Zhang, Dauphin, and Ma 2019).

In light of the above drawbacks, there is a need for a system and a method that can readily evaluate weight initialization techniques for various neural network architectures, thereby improving neural network's performance. In particular, there is a need for a system and a method that can appropriately initialize weights associated with neurons at each layer of the network to analytically preserve mean and variance of the output signals of respective layers. Further, there is a need for a system and a method that solves the problem of exploding or vanishing output signals from layers. Furthermore, there is a need for a system and a method that can dynamically adapt to each layer of the network, and can be extended to include new layer types. Yet further, there is a need for a system and a method that provides greater efficiency and stability in the learning of the neural network model. Yet further, there is a need for a system and a method that eliminates the need of using existing weight initialization techniques in incorrect settings. Yet, further, there is need for a system and a method which is easy to use and relatively accurate.

### SUMMARY OF THE INVENTION

In accordance with various embodiments of the present invention, a method for evaluating weight initialization technique for individual layers of neural network models to analytically preserve mean and variance across layers is provided. The method is implemented by a processor executing program instructions stored in a memory. The method comprising deriving a mean-variance mapping function (g-layer) corresponding to each of the respective layers of a neural network comprising a plurality of layers. The method further comprises determining association of a weight parameter (θ) with each of the respective layers of the neural network. Yet further, the method comprises evaluating a weight initialization technique for selecting an initial value of respective weight parameter (θ) associated with each layer determined to have associated weight parameter (θ) out of the plurality of layers. The weight initialization technique is evaluated based on the derived mean-variance mapping function (g-layer) corresponding to said each layer, such that a mean (μ_{Out}) and a variance (vₒᵤₜ) of respective output signals of said each layer is zero and one, respectively.

In accordance with various embodiments of the present invention, a system for evaluating weight initialization technique for individual layers of neural network models to analytically preserve mean and variance across layers is provided. The system comprises a memory storing program instructions, a processor configured to execute program instructions stored in the memory, and a weight initialization engine executed by the processor. The system configured to derive a mean-variance mapping function (g-layer) corresponding to each of the respective layers of a neural network comprising a plurality of layers. Further, the system is configured to determine association of a weight parameter (θ) with each of the respective layers of the neural network. Yet further, the system is configured to evaluate a weight initialization technique for selecting an initial value of respective weight parameter (θ) associated with each layer determined to have associated weight parameter (θ) out of the plurality of layers. The weight initialization technique is evaluated based on the derived mean-variance mapping function (g-layer) corresponding to said each layer, such that a mean (μ_{Out}) and a variance (vₒᵤₜ) of respective output signals of said each layer is zero and one, respectively.

In accordance with various embodiments of the present invention, a computer program product is provided. The computer program product comprises a non-transitory computer-readable medium having computer-readable program code stored thereon, the computer-readable program code comprising instructions that, when executed by a processor, cause the processor to derive a mean-variance mapping function (g-layer) corresponding to each of the respective layers of a neural network comprising a plurality of layers. Further, association of a weight parameter (θ) with each of the respective layers of the neural network is determined. Yet further, a weight initialization technique for selecting an initial value of respective weight parameter (θ) associated with each layer determined to have associated weight parameter (θ) out of the plurality of layers is evaluated. The weight initialization is evaluated based on the derived mean-variance mapping function (g-layer) corresponding to said each layer, such that a mean (μ_{Out}) and a variance (vₒᵤₜ) of respective output signals of said each layer is zero and one, respectively.

### BRIEF DESCRIPTION OF THE ACCOMPANYING DRAWINGS

The present invention is described by way of embodiments illustrated in the accompanying drawings wherein:

FIG. 1 is a block diagram of an environment including a system for evaluating weight initialization techniques for individual layers of neural network models such that the mean and variance is preserved to zero and one, respectively across layers of the network, in accordance with various embodiments of the present invention;

FIG. 1A is a neural network model, in accordance with an exemplary embodiment of the present invention;

FIG. 1B illustrates the performance of the CNN-C network with the default initialization in comparison with the layer-wise weight initialization evaluated by system of the present invention in different settings of hyper parameters including activation function, dropout rate, weight decay and learning rate multiplier;

FIG. 2 is a flowchart illustrating a method for evaluating respective weight initialization techniques for individual layers of neural network models such that the mean and variance is preserved to zero and one, respectively across layers of the network, in accordance with various embodiments of the present invention; and

FIG. 3 illustrates an exemplary computer system in which various embodiments of the present invention may be implemented.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention. The term “weight initialization” as used in the specification refers to the practice of setting initial values of weights associated with each layer of neural network prior to training. The term “weight initialization technique” as used in the specification refers to the mechanism of evaluating a sampling range for the weights, and setting initial values of weights in a neural network layer from the evaluated range before training begins in order to stabilize signals and/or achieve any other objective. The term “mean” as used in the specification refers to aggregated value of inputs or outputs of a single layer divided by the number of inputs/outputs. The term “variance” is the expected value of squared deviation from the mean. For example: If the input or output is X, then the variance can be derived from the formula E[(X−E[X])\hat{ }2]. Here “E” is the expected value operation, E(x) is the mean, and “\hat{ }2” is an exponent of two.

The present invention discloses a system and a method for evaluating weight initialization techniques for individual layers of various neural network architectures. In particular, the present invention provides for evaluating weight initialization techniques for individual layers of deep learning neural network models by preserving mean and variance of output signals propagated through each of the layers. The preserving of mean and variance of the output signal across the layers to zero and one respectively ensures that the weight parameter is initialized properly, and the problem of exploding and/or vanishing output signals is eliminated. In operation, the present invention provides for receiving a neural network model having a plurality of layers (L), each of the plurality of layers having one or more neurons connected with one or more neurons of the next layer and/or any subsequent layer. The present invention further provides for receiving an input dataset at the input layer of the model, whereby the input dataset is processed by the input layer and propagated to next layer, and the process continues up to the output layer. Further, the present invention provides for deriving a mean-variance mapping function (g-layer) for each layer associated with the received neural network model based on any of the following: a weight parameter associated with the layer (L), type of layer (L), and activation function associated with layer (L). The mean-variance mapping function (g-layer) is derived in order to map the mean and variance of the input signal at respective layers of the network with the mean and variance of the output signal after propagation through said respective layers. Yet further, the present invention, provides for determining if a weight parameter is associated with layer (L=1). In case no weight parameter is associated with layer (L=1), then mean and variance of the output signal propagating through layer (L=1) is computed by incorporating the mean and variance of the input signal of layer (L=1) into the derived mean-variance mapping function (g-layer) associated with layer (L=1). The mean and variance of the input signal of layer (L=1) is same as the mean and variance of the output signal of any preceding layer directly providing input to the layer (L=1) or is computed by aggregation of input data if layer (L=1) is an input layer. In case a weight parameter is associated with layer (L=1), then a weight initialization technique is evaluated for setting initial value of the weight parameter associated with layer (L=1) using the derived mean-variance mapping function for layer (L=1), such that the mean of the output signal of layer (L=1) is zero and the variance is one. Further, the present invention provides for analyzing each layer out of plurality of layers to evaluate weight initialization technique for respective layers up to the output layer. In particular, the present invention provides for repeating the step of determining association of weight parameter, computing mean and variance of the output signal propagating through layer (L) or evaluating a weight initialization technique of layer (L) until L=output layer.

The present invention would now be discussed in context of embodiments as illustrated in the accompanying drawings.

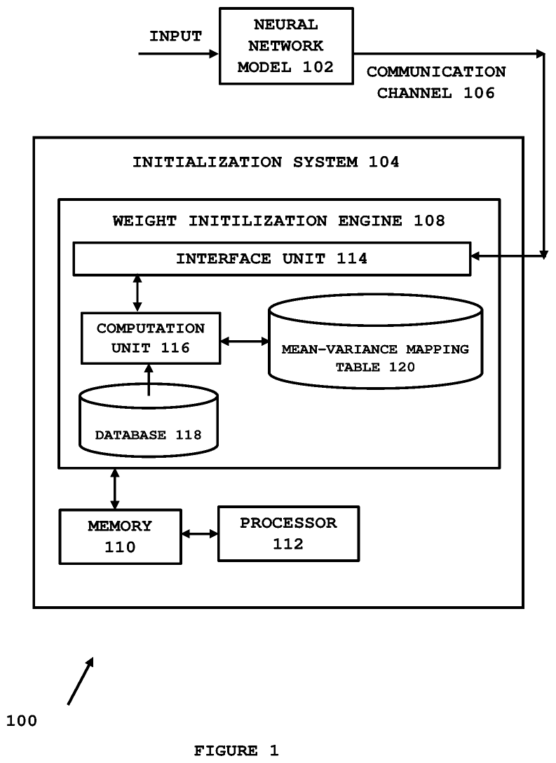

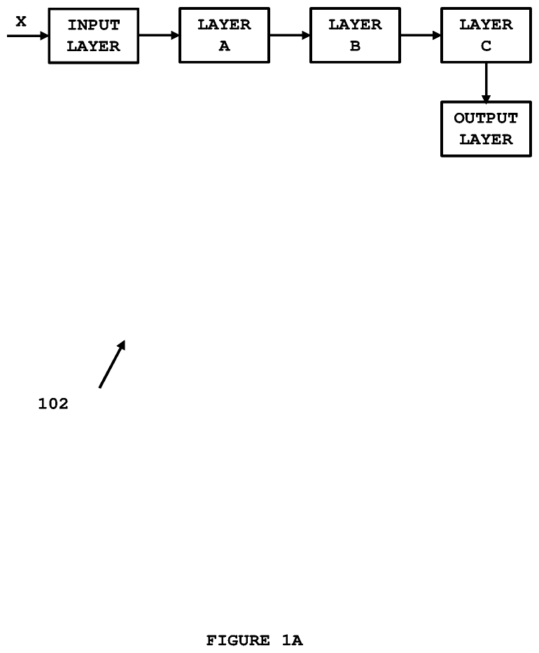

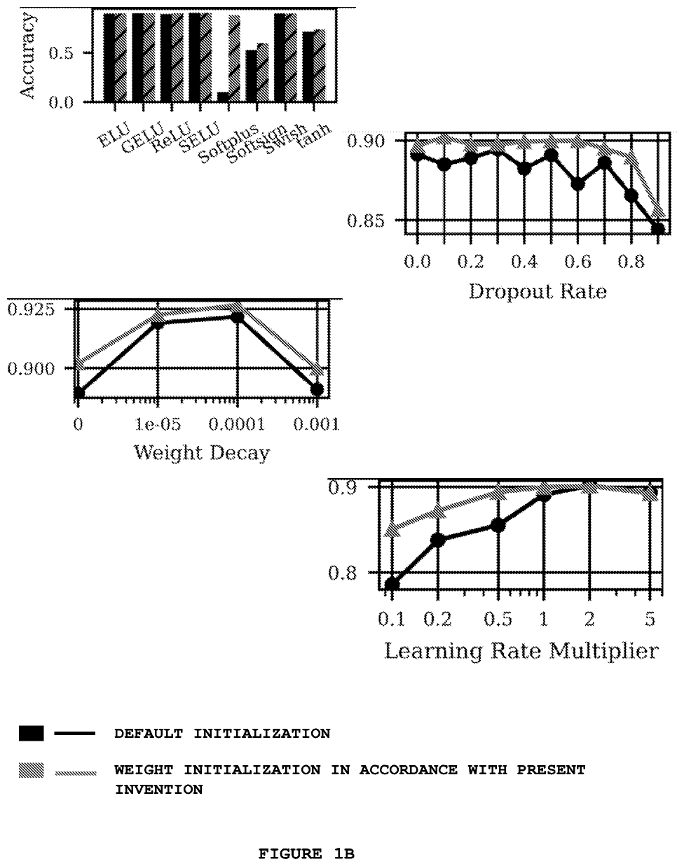

Referring to FIG. 1, a block diagram of an environment including a system for evaluating weight initialization techniques for individual layers of neural network models such that the mean and variance is preserved to zero and one, respectively across layers of the network is illustrated. In an embodiment of the present invention the environment 100 includes an untrained neural network model 102, and a system for evaluating weight initialization techniques for individual layers of neural network model, hereinafter referred to as initialization system 104.

In accordance with various embodiments of the present invention, the untrained neural network model 102 may be any existing neural network or any newly designed neural network having multiple node layers, specific activation functions, topologies etc. In accordance with various embodiments of the present invention, the neural network includes at least one input layer, one or more hidden layers and an output layer. Each of the node layers comprise one or more neurons. In an exemplary embodiment of the present invention as shown in FIG. 1A, the untrained neural network model 102 comprises an input layer having (N) neurons (not shown); three hidden layers (layer A, layer B, layer C), each having (P) neurons (not shown); and an output layer. In an embodiment of the present invention, the untrained neural network model 102 is uploaded to the initialization system 104 through an I/O device (not shown) or a repository, such as Tensorflow model repository or any other device via a communication channel 106. Examples of the communication channel 106 may include, but are not limited to, an interface such as a software interface, a physical transmission medium such as a wire, or a logical connection over a multiplexed medium such as a radio channel in telecommunications and computer networking. Examples of radio channel in telecommunications and computer networking may include, but are not limited to, a Local Area Network (LAN), a Metropolitan Area Network (MAN), and a Wide Area Network (WAN).

In accordance with various embodiments of the present invention, the initialization system 104 may be a software executable by a computing device or a combination of software and hardware. In an embodiment of the present invention as shown in FIG. 1, the initialization system 104 is a combination of software and hardware. In an embodiment of the present invention, the initialization system 104 may be implemented as a client-server architecture, wherein a client-computing device (not shown) accesses a server hosting the initialization system 104 via the communication channel 106 to receive weight initialization techniques for respective layers of neural network model 102. In an exemplary embodiment of the present invention, the functionalities of the initialization system 104 are delivered as Software as a Service (SAAS) to one or more client-computing devices (not shown). In another embodiment of the present invention, the initialization system 104 may be implemented in a cloud computing architecture in which data, applications, services, and other resources are stored and delivered through shared data-centers. In an exemplary embodiment of the present invention, the initialization system 104 is a remote resource implemented over the cloud and accessible for shared usage in a distributed computing architecture by multiple client-computing devices (not shown). In an exemplary embodiment of the present invention, the initialization system 104 may be accessed via an IP address/domain name. In another exemplary embodiment of the present invention, the initialization system 104 may be accessed via a user module of the initialization system 104 executable on the client-computing device (not shown).

In another embodiment of the present invention, the initialization system 104 is a software installable and executable on the client-computing device (not shown). In an embodiment of the present invention, the client-computing device may be a general purpose computer, such as a desktop, a laptop, a smartphone and a tablet; a super computer; a microcomputer or any device capable of executing instructions, connecting to a network and sending/receiving data. In an embodiment of the present invention, the client-computing device is configured with a User Interface (UI) of the initialization system 104 to at least upload or design neural network models, provide input data, and receive weight initialization techniques among other things. In yet another embodiment of the present invention, the initialization system 104 is a software implemented as a wrapper around the neural network model 102 in a neural network repository (not shown) such as TensorFlow.

In an embodiment of the present invention, the initialization system 104 comprises a weight initialization engine 108, a memory 110, and a processor 112. The weight initialization engine 108 is operated via the processor 112 specifically programmed to execute instructions stored in the memory 110 for executing functionalities of the weight initialization engine 108. In accordance with various embodiments of the present invention, the memory 110 may be a Random Access Memory (RAM), a Read-only memory (ROM), a hard drive disk (HDD) or any other memory capable of storing data and instructions.

In accordance with various embodiments of the present invention, the weight initialization engine 108 is a self-contained engine configured to retrieve and/or design complex neural network models, analyze input signals and corresponding output signals propagating across each layer of the neural network, identify layer types and associated activation functions, determine weight parameter associated with each layer, compute mean-variance mapping function for each layer, and evaluate weight initialization techniques for each layer.

In accordance with various embodiments of the present invention, the weight initialization engine 108 comprises an interface unit 114, a computation unit 116, a database 118 and a mean-variance mapping table 120. The various units of the weight initialization engine 108 are operated via the processor 112 specifically programmed to execute instructions stored in the memory 110 for executing respective functionalities of the multiple units (114, 116 118, and 120) in accordance with various embodiments of the present invention.

In accordance with various embodiments of the present invention, the interface unit 114 is configured to facilitate communication with the I/O device (not shown), the client-computing device (not shown), and any other external resource (not shown). Examples of the external resource may include, but are not limited to, storage devices, model repositories, such as tensor flow repository, and third party systems such as computing resources, databases etc. In an embodiment of the present invention, the interface unit 114 is configured to provide communication with the I/O device (not shown) associated with the initialization system 104 for updating system configurations, receiving or designing neural network models, receiving input data, receiving input from the system admins among other things.

In an embodiment of the present invention, the interface unit 114 is configured with any of the following: a web gateway, a mobile gateway, a Graphical User Interface (GUI), an integration interface, a configuration interface and a combination thereof, to facilitate interfacing with the client-computing device (not shown), the I/O device (not shown) and other external resource (not shown). In an exemplary embodiment of the present invention, the integration interface is configured with one or more APIs, such as REST and SOAP APIs to facilitate smooth interfacing and/or integration with the client-computing device and/or the external resources. In an embodiment of the present invention, the configuration interface provides communication with the Input/output device (not shown) for receiving, updating and modifying administration configurations from system admins, and receiving other data.

In an embodiment of the present invention, the GUI is accessible on the client-computing device (not shown) to facilitate user interaction. In an exemplary embodiment of the present invention, the Graphical User Interface (GUI) allows a user to create login credentials, sign-in using the login credentials, upload, select and design neural network models, select layer type, select activation functions associated with layer types, select hyper parameters, receive input and output signals mean-variance mapping functions, and receive weight initialization techniques, amongst other things. In an embodiment of the present invention, the graphical user interface (GUI) may be accessed from the client-computing device (not shown) through a web gateway via a web browser. In another embodiment of the present invention, the GUI may be accessed by mobile gateway using a user module installable on the client-computing device. In an embodiment of the invention, where the initialization system 104 is a software installable and executable on the client-computing device (not shown), the GUI along with other units is locally accessible on the client-computing device (not shown).

In accordance with various embodiments of the present invention, the computation unit 116 is configured to build a mean-variance mapping table 120 comprising a mean-variance mapping function (g-layer) for each of the layers used in any of the modern deep learning neural network models. In an embodiment of the present invention, the computation unit 116 is configured to build a mean-variance mapping table 120 comprising a mean-variance mapping function (g-layer) for each of the layers of the untrained neural network model 102. In accordance with various embodiments of the present invention, a mean-variance mapping function (g-layer) corresponding to any layer (L) of the neural network having no associated weight parameter (θ) is representative of a function derived to map a mean and a variance of input signal of any layer (L) with a mean and a variance of output signal after propagation through said any layer. In accordance with various embodiments of the present invention, a mean-variance mapping function (g-layer) corresponding to any layer of the neural network having an associated weight parameter (θ) is representative of a function derived to map a mean and a variance of an input signal of said any layer and the weight parameter (θ) associated with said any layer with a mean and a variance of an output signal after propagation through said any layer. In accordance with various embodiments of the present invention, the computation unit 116 is configured to derive a mean-variance mapping function (g-layer) for each of the layers based on any of the following: a weight parameter associated with the layer (L), type of layer (L), activation function associated with the layer (L) and a combination thereof using analytics and/or computation techniques as exemplified below. In an exemplary embodiment of the present invention, the computation unit 116 is configured to derive a mean-variance mapping function (g-layer) for each of the layers of the neural network model 102 and/or the majority of layers of modern deep learning neural network models using analytics based on user inputs.

The following examples are associated with most commonly used layers of modern neural network models available in Tensor Flow. Similar, analytic approach is to be used for new layers or layers not exemplified herein. In the examples, x denotes an input to a layer (L), and y is the output. In the example L denotes the number of layer of the neural network model 102, where L is a positive integer. The mean and variance of the incoming signal (input signal) μᵢₙ, vᵢₙ and mean and variance of the outgoing signal (output signal) μ_{Out}, vₒᵤₜ are denoted as μᵢₙ:=E(x), μ_{Out}, :=E(y), and vᵢₙ:=Var(x), and vₒᵤₜ:=Var(y).

### Example 1 for Deriving Mean-Variance Mapping Function (G-Layer) for Convolution and Dense Layers

Assuming, inputs to each layer are independent and normally distributed, if layer (L) is a feedforward convolution layer or a dense layer, the output (y)=Wx+b, where x is the input, W is a fan_out x fan_in weight matrix, and b is a vector of biases.

Further, assuming that the elements of W are mutually independent and from the same distribution, and likewise for the elements of x, and also assuming that W and x are independent of each other. The following relationship mapping the mean of the output signal of layer (L) with the mean of the input signal of layer (L) is derived:

μₒᵤₜ=E(W)μᵢₙ

νₒᵤₜ=fan_in Var(W)(νᵢₙ+μᵢₙ\hat{ }2)

Further, considering W has zero mean and expanding the product of independent random variables yields, the following relationship mapping the variance of the output signal of layer (L) with the variance of the input signal of layer (L) is derived:

νₒᵤₜ=fan_in Var(W)(νᵢₙ+μᵢₙ\hat{ }2)

The following relationships

μₒᵤₜ=E(W)μᵢₙ, and νₒᵤₜ=fan_in Var(W) (νᵢₙ+μᵢₙ\hat{ }2) denote mean-variance mapping function (g-layer) for layer (L), where layer (L) may be selected from a Conv1D, Conv2D, Conv3D, and dense layers.

### Example 2 for Deriving Mean-Variance Mapping Function (g-layer) for Layers with Activation Functions

Assuming pN(x;μ;σ) denotes the probability density function of a Gaussian distribution with mean μ and standard deviation σ. By the law of the unconscious statistician,

μₒᵤₜ=∫_{-∞}^{∞}f(x)pN(x; μin, \sqrt{vin})dx,

νₒᵤₜ=∫_{-∞}^{∞}f(x)²pN(x; μin, \sqrt{vin})dx−μ²out

The following relationships

μₒᵤₜ=∫_{-∞}^{∞}f(x)pN(x; μin, \sqrt{vin})dx, and

νₒᵤₜ=∫_{-∞}^{∞}f(x)²pN(x; μin, \sqrt{vin})dx−μ²out

denote mean-variance mapping function (g-layer) for a layer, where the layer has an activation function including, but not limited to, elu, exponential, gelu, hard sigmoid, LeakyReLU, linear, PReLU, ReLU, selu, sigmoid, softplus, softsign, swish, tanh,and ThresholdedReLU, and any integrable activation function f vide Clevert, Unterthiner, and Hochreiter 2015; Hendrycks and Gimpel 2016b; Maas, Hannun, and Ng 2013; He et al. 2015; Nair and Hinton 2010; Klambauer et al. 2017; Ramachandran, Zoph, and Le 2018; Elfwing, Uchibe, and Doya 2018; Courbariaux, Bengio, and David 2015).

Further, the above integrals are computed for an arbitrary activation function f with adaptive quadrature, which is a well-established numerical integration approach that approximates integrals using adaptively refined subintervals (Piessens et al. 2012).

### Example 3 for Deriving Mean-Variance Mapping Function (G-Layer) for Dropout Layers

It is known that dropout layers randomly set rate percentage of their inputs to zero (vide Srivastava et al. 2014). Therefore, μout=μin (1-rate) and νout=νin (1-rate). The aforementioned relationships denote mean-variance mapping function (g-layer) for any layer (L), where layer (L) may be selected from SpatialDropout1D, SpatialDropout2D, and SpatialDropout3D layers.

For regular Dropout layers, the values are automatically scaled by 1/(1-rate) in tensor flow to avoid a mean shift towards zero. Adjusting for this change, the mean-variance mapping function (g-layer) for any regular dropout layer (L) is derived as μout=μin and νout=νin (1-rate).

### Example 4 for Deriving Mean-Variance Mapping Function (G-Layer) for Pooling Layers

Assuming op(.) as the average operation for an average pooling layer, and the maximum operation for a max pooling layer. Further, defining K to be the pool size of the layer. For standard 1D, 2D, and 3D pooling layers, K would equal k, k×k, and k×k×k, respectively.

The global pooling layers can be seen as special cases of the standard pooling layers where the pool size is the same size as the input tensor, except along the batch and channel dimensions. Analytically, the following relationship mapping the mean and variance of the output signal of layer (L) with the mean and variance of the input signal of layer (L) is derived:

μₒᵤₜ=∫ . . . ∫_{R}_{^{K}}op(x1, x2, . . . , xK).Πᵢ₌₁^{K}pN(xi;μᵢₙ, \sqrt{νin})dx₁ dx₂ . . . dx_{K},

νₒᵤₜ=∫ . . . ∫_{R}_{^{K}}op(x1, x2, . . . , xK)².Πᵢ₌₁^{K}pN(xi;μᵢₙ, \sqrt{νin})dx₁ dx₂ . . . dx_{K}−μ²out,

where the xi represents tensor entries within a pooling window. However, even a modest 3×3 pooling layer requires computing nine nested integrals, which is prohibitively expensive. Accordingly, for 3×3 pooling layer, a Monte Carlo simulation is more feasible. Assuming sample x1ⱼ, x2ⱼ, . . . xKⱼ from N(μᵢₙ, √vᵢₙ)for j=1, . . . , S and return, the following relationship mapping the mean and variance of the output signal of layer (L) with the mean of the input signal of layer (L) is derived:

$${μ}_{out} = \frac{1}{s} {\sum }_{j = 1}^{s} op ( x {1}_{j} , x {2}_{j} , … {xK}_{j} ) ,$$

$${ν}_{out} = \frac{1}{s} {\sum }_{j = 1}^{s} {op ( x {1}_{j} , x {2}_{j} , … {xK}_{j} )}^{2} - {μ}_{o u t} .$$

The above relationships denote mean-variance mapping function (g-layer) for pooling layer (L), selected from AveragePooling1D, AveragePooling2D, AveragePooling3D, MaxPooling1D, MaxPooling2D, MaxPooling3D, GlobalAveragePooling1D, GlobalAveragePooling2D, GlobalAveragePooling3D, GlobalMaxPooling1D, GlobalMaxPooling3D.

### Example 5 for Deriving Mean-Variance Mapping Function (G-Layer) for Normalization Layers

Batch Normalization normalizes the input to have mean zero and variance one. Thus, μₒᵤₜ=0 and νₒᵤₜ=1 for normalization layers.

### Example 6 for Deriving Mean-Variance Mapping Function (G-Layer) for Arithmetic Operators

Assuming the input tensors x1, x2, . . . xN with means μᵢₙ₁; μᵢₙ₂, . . . , μ_{inN} and variances vᵢₙ₁, vᵢₙ₂, . . . , v_{inN} are independent. The following mean and variance mapping functions are derived.

For Add operator: μₒᵤₜ=Σₜ₌₁^{N} μᵢₙᵢ and νₒᵤₜ=Σₜ₌₁^{N} vᵢₙᵢ

For Average:

$${μ}_{out} = \frac{1}{N} {\sum }_{t = 1}^{N} {μ}_{ini} and {v}_{out} = \frac{1}{{N}^{2}} {\sum }_{t = 1}^{N} {v}_{ini}$$

For subtract: μₒᵤₜ=μᵢₙ₁−μᵢₙ₂ and νₒᵤₜ=νᵢₙ₁+νᵢₙ₂

For multiply: μₒᵤₜ=Πₜ₌₁^{N}μᵢₙ₁ and νₒᵤₜ=Πₜ₌₁^{N}(νᵢₙ₁+μ²ᵢₙᵢ)−Πₜ₌₁^{N}μ²ᵢₙᵢ

### Example 7 for Deriving Mean-Variance Mapping Function (G-Layer) for Concatenation Layers

Assuming the inputs x1, x2, . . . xN with means μᵢₙ₁; μᵢₙ₂, . . . , μ_{inN} and variances vᵢₙ₁, vᵢₙ₂, . . . , v_{inN} are independent. Further, assuming that input xi and Ci have elements. The following mean-variance mapping function (g-layer) for concatenation layers (L) is derived:

$${μ}_{out} = \frac{1}{\sum Ci} {\sum }_{t = 1}^{N} Ci {μ}_{in} ,$$

$${v}_{out} = \frac{1}{\sum Ci} {\sum }_{t = 1}^{N} Ci ( {v}_{in 1} + {μ}_{ini}^{2} ) - {μ}_{o u t}^{2} .$$

### Example 8 for Deriving Mean-Variance Mapping Function (G-Layer) for Recurrent Layers

A Monte Carlo simulation is used to estimate the outgoing mean and variance for recurrent layers, including GRU, LSTM, and SimpleRNN (Chung et al. 2014; Hochreiter and Schmidhuber 1997). Recurrent layers often make use of activation functions like sigmoid and tanh that constrain the scale of the hidden states. Therefore, recurrent layers are initialized with a default scheme or according to recent research in recurrent initialization vide Chen, Pennington, and Schoenholz 2018; Gilboaet al. 2019).

### Example 9 for Deriving Mean-Variance Mapping Function (G-Layer) for Padding Layers

Padding Layers ZeroPadding1D, ZeroPadding2D, and ZeroPadding3D layers augment the borders of the input tensor with zeros, increasing its size. Assuming Z to be the proportion of elements in the tensor that are padded zeros. Then, z=(padded_size−original_size)/padded, μₒᵤₜ=μᵢₙ(1−z), and vₒᵤₜ=vᵢₙ(1−z). The following relationships μₒᵤₜ=μᵢₙ(1−z), and vₒᵤₜ=vᵢₙ(1−z) denote mean-variance mapping function(g-layer) for concatenation layers (L).

Example 10 for Deriving Mean-Variance Mapping Function (G-Layer) for Shape Adjustment Layers

Many layers alter the size or shape of the input tensor but do not change the distribution of the data. These layers include Flatten, Permute, Reshape, UpSampling1D, UpSampling2D, UpSampling3D, Cropping1D, Cropping2D, and Cropping3D layers. For these layers, the mean-variance mapping function (g-layer) is μₒᵤₜ=μᵢₙ and vₒᵤₜ=vᵢₙ.

Example 11 for Deriving Mean-Variance Mapping Function (G-Layer) for Input Layers

As the InputLayer simply exposes the model to the data, therefore μₒᵤₜ=μ_{data} and vₒᵤₜ=v_{data}. In a use case where the InputLayer does not directly connect to the training data, the mean-variance mapping function (g-layer) is μₒᵤₜ=μᵢₙ and vₒᵤₜ=vᵢₙ.

In an embodiment of the present invention, the computation unit 116 is configured to build a mean-variance mapping table 120 by storing each of the derived mean-variance mapping function (g-layer) for individual layers in the table.

In another embodiment of the present invention, the mean-variance mapping table 120 comprising a mean-variance mapping function (g-layer) for majority of the layers used in any of the modern deep learning neural network models is predefined within the initialization system 104. In an embodiment of the present invention, the computation unit 116 is configured to derive mean-variance mapping function (g-layer) for the layers that are not predefined within the initialization system 104. In another embodiment of the present invention, the computation unit 116 is configured to assume that for a layer that is not predefined within the initialization system 104, the mean and variance remains unchanged after propagation through said layer, such that g_{layer}(μᵢₙ, vᵢₙ)=μᵢₙ, vᵢₙ.

In accordance with various embodiments of the present invention, the computation unit 116 is configured to receive an untrained neural network model 102. The untrained neural network model 102 comprises a plurality of layers (L). Each layer (L) of the neural network model is connected with the next or any subsequent layer. In particular, one or more neurons of one layer are connected with one or more neurons of the next layer or any subsequent layer up to the output layer. Further, the output of one layer becomes the input of the next layer, and therefore, the mean and variance of output signal of one layer is the mean and variance of the input signal of the next layer. Referring to FIG. 1A, in accordance with an exemplary embodiment of the present invention, the neural network model 102 comprises an input layer having (N) neurons; three hidden layers (layer A, layer B, layer C), each having (P) neurons; and an output layer. In accordance with the above example, the number of layers=5. Further, the input layer is connected with layer A; layer A is connected with layer B, layer B is connected with layer C, and finally layer C is connected with the output layer. The mean and variance of the output signal of input layer (L=1) is the mean and variance of the input signal of the layer A (L=2). Similarly, the mean and variance of output signal of layer A is the mean and variance of input signal of layer B. In particular, the mean and variance of the output signal of layer (L−1) is same as the mean and variance of the input signal of layer (L).

Further, the computation unit 116 is configured to identify the type of layer (L) and an activation function associated with the layer (L). In an embodiment of the present invention, the computation unit 116 is configured to identify the type of layer and the activation function associated with a layer by analyzing the received neural network model 102. In an embodiment of the present invention, the type of layer and the activation function are identified based on user selection via the interface unit 114. In an embodiment of the present invention, the supported activation functions include, but are not limited to, elu, exponential, gelu, hard sigmoid, LeakyReLU, linear, PReLU, ReLU, selu, sigmoid, softplus, softsign, swish, tanh, ThresholdedReLU, and any other integrable activation function f.

In accordance with various embodiments of the present invention, the computation unit 116 is configured to determine if a weight parameter θ is associated with a layer (L) of the received untrained neural network model 102 to determine if the layer requires weight initialization. In operation, the computation unit 116 is invoked to determine if a weight parameter θ is associated with a layer (L) on receiving an input at layer (L). For example, with reference to FIG. 1A, an input dataset (x) is received at the input layer (L=1) associated with neural network model 102, where the input dataset(x) is processed and propagated to next layer (L=2), and the process continues up to the output layer (L=5) The computation unit 116 is invoked to determine if a weight parameter θ is associated with the input layer on receiving an input dataset at the input layer. Similarly, the computation unit 116 is invoked to determine if a weight parameter θ associated with layer A on receiving an input signal for processing by layer A. Similarly, computation unit 116 is invoked up to the output layer.

In an embodiment of the present invention, computation unit 116 is configured to determine if a weight parameter θ is associated with a layer (L) based on the type of layer. In an embodiment of the present invention, the information associated with the type of layers having weights and not having weights is predefined in the database 118. For instance, layers, such as convolution or dense layers have weights and dropout and pooling layers do not have weights. The computation unit 116 is configured to access the database to determine if a weight parameter θ is associated with a layer (L). In an example with reference to FIG. 1A, it is determined that Layer A and Layer C have weights that require initialization, but Layer B does not have weights, and does not require weight initialization.

The computation unit 116 is configured to compute the mean and variance of the output signal propagating through layer (L) if no weight parameter is associated with the layer (L). In accordance with various embodiments of the present invention, the computation unit 116 is configured to determine the mean and variance of the output signal propagating through layer (L) by incorporating the mean and variance of the input signal of layer (L) into a mean-variance mapping function (g-layer) associated with layer (L). In operation, the computation unit 116 is configured to select a mean-variance mapping function (g-layer) for layer (L) from the mean-variance mapping table 120 based any of the following: type of layer (L), activation function associated with the layer (L) or a combination thereof if no weight parameter is associated with the layer (L). In another embodiment of the present invention, the computation unit 116 is configured to derive a mean-variance mapping function (g-layer) for layer (L) using analytics based on type of layer (L) and/or activation function associated with the layer (L) if no weight parameter is associated with the layer (L). Further, the computation unit is configured to compute the mean and variance of the input signal of layer (L). As already described above, the mean and variance of the input signal of layer (L) is same as the mean and variance of the output signal of layer (L−1). Yet further, the mean and variance of the input signal of layer (L) are incorporated into selected mean-variance mapping function (g-layer) for layer (L) to compute the mean and variance of the output signal after propagating through layer (L).

For example: if (μᵢₙ, vᵢₙ) are the input mean and variance of the input signal of layer (L), then after incorporating (μᵢₙ, vᵢₙ), the function g(layer) provides a relationship with the mean and variance of the output signal of layer (L) i.e. (μ_{Out}, Vₒᵤₜ), such that (μ_{Out}, Vₒᵤₜ) can be computed.

g-layer: (μᵢₙ, vᵢₙ)→(μ_{Out}, vₒᵤₜ)

In an example with reference to FIG. 1A, layer B may be a dropout layer. As dropout layers do not have weights, the mean-variance mapping function for a dropout layer (g-dropout) is used for computing the mean and variance of the output signal of the dropout layer. The function (g-dropout) as derived and maintained in the mean-variance mapping table 120 is as follows:

g-dropout: [μₒᵤₜ=u(1−p); vₒᵤₜ=v(1−p)] where μᵢₙ=u and vᵢₙ=v, and p is the percentage of inputs set to zero by the dropout layer.

In accordance with various embodiments of the present invention, the computation unit 116 is configured to evaluate a weight initialization technique for layer (L), in case a weight parameter (θ) is associated with layer (L). In an embodiment of the present invention, a weight initialization technique is evaluated for setting the initial value for the weight parameter (θ) associated with the input signal of layer (L), such that the mean of the output signal of layer (L) is zero and the variance is 1 after applying a mean-variance mapping function for the layer (L). In operation, the computation unit 116 is configured to derive a mean-variance mapping function (g-layer) for layer (L) using analytics based on the weight parameter (θ) and the type of layer (L) and/or activation function associated with the layer (L). In another embodiment of the present invention, the computation unit 116 is configured to select a mean-variance mapping function (g-layer) for layer (L) from the mean-variance mapping table 120 based on the type of layer (L) and/or activation function associated with the layer (L). Further, the computation unit is configured to compute the mean and variance of the input signal (μᵢₙ, vᵢₙ) of layer (L). As already described above with reference to FIG. 1A, the mean and variance of the input signal of layer (L) is same as the mean and variance of the output signal of layer (L−1). Yet further, the mean and variance of the input signal of layer (L) (μᵢₙ, vᵢₙ) are incorporated into derived/selected mean-variance mapping function (g-layer) for layer (L), such that the mean of the output signal of layer (L) (μ_{Out}) is zero and the variance (vₒᵤₜ) is one after applying the computed mean-variance mapping function for layer (L).

g-layer, θ (μᵢₙ, vᵢₙ)=(0,1), where g-layer is the mean-variance mapping function, θ is the weight parameter, μᵢₙ mean of the input signal, vᵢₙ is the variance of the input signal.

In accordance with various embodiments of the present invention, the computation unit 116 is configured to evaluate the weight initialization technique for setting the initial value of weight parameter (θ) associated with the layer (L). In particular, the computation unit 116 is configured to evaluate a weight distribution for the weight parameter (θ) and ascertain a sampling range for the weight parameter (θ). Further, the initial values of weight parameter (θ) of the layer (L) are selected from the ascertained range such that the mean (μ_{Out}) of the output signal of the layer (L) is zero and the variance (vₒᵤₜ) is 1. In an exemplary embodiment of the present invention, the weight distribution may be selected from a normal distribution, uniform distribution or any other distribution.

### Example a

In an example with reference to FIG. 1A, an input dataset (x) enters the input layer (L=1). The output of the input layer (L=1) is the input of the layer A (L=2). The mean μᵢₙ and variance vᵢₙ of the input dataset (x) of the input layer are E(x) and Var(x), respectively. Subsequent to passing through the input layer (L=1), the output is y, and the output signal has a mean μ_{Out}=E(y) and variance vₒᵤₜ=var(y). The dataset x is centered and normalized, such that the output signal of the input layer has a μ_{Out}=zero and vₒᵤₜ=1. Alternatively, if the data distribution is known and has mean u_data and variance v_data, this can be used to compute μ_{Out} and vₒᵤₜ. The input layer does not do anything and has no weights; it is only used to connect the neural network to the dataset. In the example, it is determined that Layer A and Layer C have weights that require initialization, but Layer B does not have weights, and does not require weight initialization.

For Layer A, the mean-variance mapping function (g-layer) is derived. Further, it can be observed that the output signal of the input layer is the input signal for layer A, therefore input mean and variance are μᵢₙ=E(y), vᵢₙ=var(y). Finally, the weight parameter (θ) for layer A is initialized, such that output mean=0 and variance=1 after incorporating μᵢₙ=E(y), vᵢₙ=var(y) in the derived mean-variance mapping function (g-layer).

For Layer C, weight initialization is required, however, the mean and variance of the input signal to Layer C is unknown. The mean and variance of the input signal to Layer C is same as the mean and variance of the output signal of layer B. Therefore, the mean and variance of the output signal of layer B are computed.

For Layer B, the input mean and variance is known (which is the same as the output mean and variance from Layer A) i.e. 0,1. Further, the mean-variance mapping function (g-layer) for layer B is derived. The output mean and variance of Layer B (which will be passed as the input mean and variance for Layer C) is computed by incorporating the input mean and variance (0,1) for layer B into the function (g-layer). Assuming the output of Layer B has mean=u and variance=v,

For layer C, the incoming signal has mean=u and variance=v (which is the output mean and variance from Layer B). The mean-variance mapping function (g-layer) for layer C is derived. Further, a weight initialization technique is evaluated to set initial values of weight parameter (θ) of Layer C, such that the output signal of Layer C has mean=0 and variance=1.

The preserving of mean and variance of the output signal to zero and one, respectively across each of the layers (L) that require weight initialization, ensures that that weight parameter (θ) is initialized properly, thereby eliminating the problem of exploding and/or vanishing output signals.

### Example b

With reference to Example 1 for deriving mean-variance mapping function (g-layer) for Convolution and Dense layers, the following mean-variance mapping function (g-layer)

μₒᵤₜ=E(W)μᵢₙ, and νₒᵤₜ=fan_in Var (W) (νᵢₙ+μᵢₙ\hat{ }2) were derived.

Since, μᵢₙ and vᵢₙ are known, a weight initialization technique for determining a sampling range for W is evaluated using the derived function (g-layer), such that μout=0 and νout=1.

As per the above relationship, the evaluated weight initialization technique includes sampling the weight W in the following range:

W˜N(1/fan_in Var(W)(νᵢₙ+μᵢₙ\hat{ }2)); or

W˜u((−sqrt(3/fan_in Var(W))(νᵢₙ+μᵢₙ\hat{ }2),(sqrt(3/fan_in Var(W)(νᵢₙ+μᵢₙ\hat{ }2))

Advantageously, the system of the present invention, affords a technical effect in the field of artificial intelligence by improving deep learning of neural network models by automatically providing weight initialization techniques that adapt to a plurality of different and unique neural network architectures. Further, the system of the present invention solves the problem of exploding and vanishing output signals by analytically tracking the mean and variance of incoming signals as they propagate through the network, and appropriately scaling the weights at each layer. Furthermore, the system of the present invention affords improved performance of various multilayer perceptron, convolutional networks, and residual networks across a range of activation functions, dropout, weight decay, learning rate, normalizer, and optimizer settings. Yet further, the system of the present invention improves performance in vision, language, tabular, multi-task, and transfer learning scenarios associated with neural architecture search and activation function meta-learning. Yet further, the system of the present invention serves as an automatic configuration tool that makes design of new neural network architectures more robust.

The performance improvement of the existing neural network models using the layer wise weight initialization provided by the system of the present invention were analyzed based on several experiments. A few of the several experiments are described below:

Convolution Neural Network (CNN) Hyper parameter variation experiment: The experiment demonstrates the performance of the system of the present invention for all CNN-C architectures (referred to in Springenberg et al. (2015)) across a wide range of hyper parameter values. The CNN model implemented for experiment includes convolutional layers, ReLU activation functions, dropout layers, and a global average pooling layer at the end of the network. The performance gains as illustrated via the graphs of FIG. 1B can be attributed to proper weight initialization evaluated as per the system of the present invention.

In the experiment, the neural network model was trained on CIFAR-10 dataset (referred to in Krizhevsky, Hinton et al. 2009) using the standard setup. In particular, the training setup was as close as possible to that of Springenberg et al. (2015). The network was trained with Stochastic Gradient Descent (SGD) and momentum 0.9. The dropout rate was 0.5 and weight decay as L2 regularization was 0.001. The data augmentation involved feature wise centering and normalizing, random horizontal flips, and random 32×32 crops of images padded with five pixels on all sides. The initial learning rate was set to 0.01 and was decreased by a factor of 0.1 after epochs 200, 250, and 300 until the training ended at epoch 350.

Further, the baseline comparison in the experiment was performed with the “Glorot Uniform” weight initialization strategy (also called Xavier initialization), where weights are sampled from μ(−√6/(fan_in+fan_out) to √6/(fan_in+fan_out)). Although, Springenberg et al. (2015) does not refer to any particular initialization strategy, “Glorot Uniform” weight initialization strategy was sufficient to replicate the results reported by Springenberg et al. (2015).

In the experiment, the network's activation function, dropout rate, weight decay, and a learning rate schedule multiplier were changed one at a time. In particular, a single experiment included separate sub-experiments, and during each of the experiments, while one hyper parameter amongst the following four hyper parameters: activation function, dropout rate, weight decay, and a learning rate schedule multiplier was varied, the other hyper parameters were fixed to the default values.

FIG. 1B illustrates the performance of the CNN-C network with the default initialization (represented by black color) in comparison with the layer-wise weight initialization (represented by grey color) evaluated by system of the present invention in different settings of hyper parameters including activation function, dropout rate, weight decay and learning rate multiplier. In conclusion, it was observed that the system of the present invention improved performance in every hyper parameter variation that was evaluated. The adaptive system of the present invention altered the initialization to account for different activation functions and dropout rates, which improved performance. Further, it was observed that for other hyper parameters, such as learning rate and weight decay, the system of the present invention resulted in a higher performing network than the default initialization. As a result, it was concluded that the present invention provides an improved default initialization for convolutional neural networks.

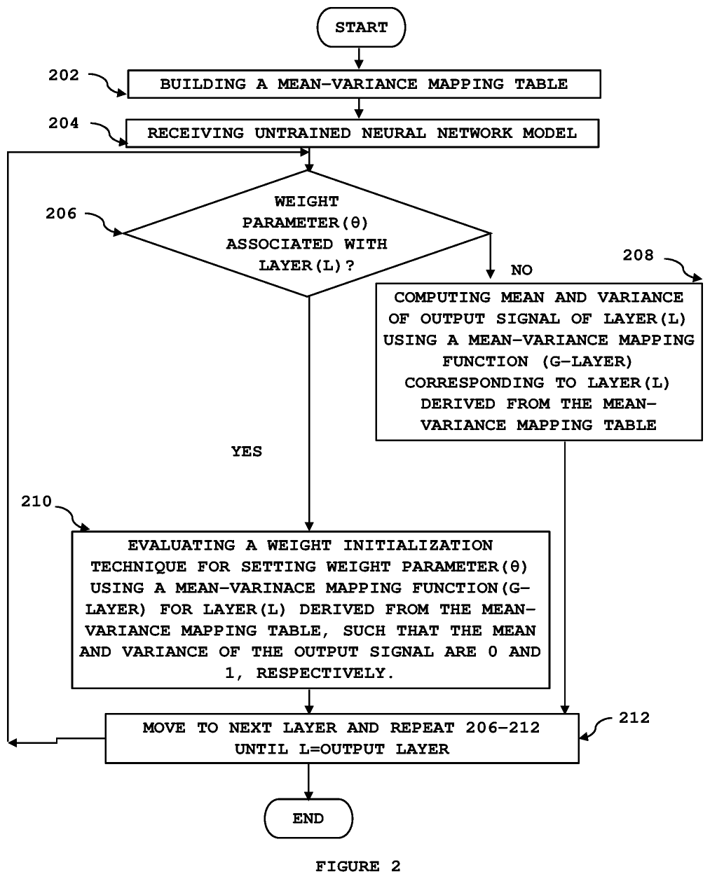

Referring to FIG. 2, a flowchart of a method for evaluating weight initialization technique for individual layers of neural network models such that the mean and variance is preserved to zero and one, respectively across layers of the network is shown, in accordance with various embodiments of the present invention.

At step 202, a mean-variance mapping table is built. In accordance with various embodiments of the present invention, a mean-variance mapping table comprising a mean-variance mapping function (g-layer) for each of the layers used in any of the modern deep learning neural network models is built. In another embodiment of the present invention, a mean-variance mapping table comprising a mean-variance mapping function (g-layer) for each of the layers of an untrained neural network model 102 (for which weight initialization is to be evaluated) is built. In accordance with various embodiments of the present invention, a mean- variance mapping function (g-layer) corresponding to any layer of the neural network having no associated weight parameter (θ) is representative of a function derived to map a mean and a variance of input signal of the any layer with a mean and a variance of output signal after propagation through said any layer. In accordance with various embodiments of the present invention, a mean-variance mapping function (g-layer) corresponding to any layer of the neural network having an associated weight parameter (θ) is representative of a function derived to map a mean and a variance of an input signal of said any layer and the weight parameter (θ) associated with said any layer with a mean and a variance of an output signal after propagation through said any layer. In accordance with various embodiments of the present invention, a mean-variance mapping function (g-layer) for each of the layers is derived based on any one of the following: a weight parameter associated with the layer, type of layer, activation function associated with the layer or any combination thereof using data analytics as exemplified in paras 33-83. Further, the derived mean-variance mapping functions (g-layer) mapped with the corresponding layers are stored in a database to build a mean-variance mapping table.

At step 204, an untrained neural network model is received. In an embodiment of the present invention, an untrained neural network model is received. The untrained neural network model comprises a plurality of layers (L), where L is a positive integer. Each layer of the neural network model is connected with the next layer or any subsequent layer of the neural network model. In particular, one or more neurons of one layer are connected with one or more neurons of the next layer or any subsequent layer up to the output layer. Further, the output of one layer becomes the input of its next layer or the subsequent layer to which it is connected, and therefore, the mean and variance of output signal of one layer is the mean and variance of the input signal of the next layer or the subsequent layer to which it is directly connected. Referring to FIG. 1A, in accordance with an exemplary embodiment of the present invention, the neural network model comprises an input layer having (N) neurons; three hidden layers (layer A, layer B, layer C), each having (P) neurons; and an output layer. In accordance with the above example the number of layers=5. Further, the input layer is connected with layer A; layer A is connected with layer B, layer B is connected with layer C, and finally layer C is connected with the output layer. The mean and variance of the output signal of input layer (L=1) is the mean and variance of the input signal of the layer A (L=2). Similarly, the mean and variance of output signal of layer A is the mean and variance of input signal of layer B. In particular, with reference to the FIG. 1A, the mean and variance of the output signal of layer (L−1) is same as the mean and variance of the input signal of layer (L).

At step 206, association of weight parameter (θ) with layer (L) of the received neural network is determined. In an embodiment of the present invention, association of a weight parameter θ with any layer of the received untrained neural network model is determined, to further determine if that layer requires weight initialization. In an embodiment of the present invention, an association of a weight parameter (θ) with any layer (L) of the received neural network is determined based on the type of layer. In operation, the information associated with the type of layers having weights and not having weights is predefined in a database. For instance, layer types, such as convolution or dense layers have weights and dropout and pooling layers do not have weights. In operation, the type of layer (L) and an activation function associated with the layer (L) are identified by analyzing the layers of received neural network model. In another embodiment of the present invention, the type of layer and the activation function are identified based on user selection. In an embodiment of the present invention, the supported activation functions include, but are not limited to, elu, exponential, gelu, hard sigmoid, LeakyReLU, linear, PReLU, ReLU, selu, sigmoid, softplus, softsign, swish, tanh, ThresholdedReLU, and any other integrable activation function f. Further, the database is accessed to determine if a weight parameter θ is associated with the layer (L) based on the identified type of the layer and/or the activation function. In an example with reference to FIG. 1A, it is determined that Layer A and Layer C have weights that require initialization, but Layer B does not have weights, and does not require weight initialization.

At step 208, if no weight parameter (θ) is associated with layer (L), mean and variance of the output signal of layer (L) is computed using a mean-variance mapping function (g-layer) corresponding to the layer (L) and the mean and variance of the input signal. In operation, a mean-variance mapping function (g-layer) for layer (L) is selected from the mean-variance mapping table based on: type of layer (L) and/or activation function associated with the layer (L) if no weight parameter is associated with the layer (L). In another embodiment of the present invention, a mean-variance mapping function (g-layer) for layer (L) is derived using analytics based on type of layer (L) and/or activation function associated with the layer (L) if no weight parameter is associated with the layer (L). Further, the mean and variance of the input signal of layer (L) is computed. The mean and variance of the input signal of layer (L) is same as the mean and variance of the output signal of the layer (L−1) or any preceding layer of the neural network directly providing input to the layer (L). The mean and variance of the input signal of layer (L) are incorporated into selected or derived mean-variance mapping function (g-layer) corresponding to the layer (L) to compute the mean and variance of the output signal after propagating through layer (L).

For example: if (μᵢₙ, vᵢₙ) are the input mean and variance of the input signal of layer (L), then after incorporating (μᵢₙ, vᵢₙ), the function g(layer) provides a relationship with the mean and variance of the output signal of layer (L) i.e. (μ_{Out}, Vₒᵤₜ), such that (μ_{Out}, Vₒᵤₜ) can be computed.

g-layer: (μᵢₙ, vᵢₙ)→(μ_{Out}, vₒᵤₜ)

In an example with reference to FIG. 1A, layer B may be a dropout layer. As dropout layers do not have weights, the mean-variance mapping function for a dropout layer (g-dropout) is used for computing the mean and variance of the output signal of the dropout layer. The function (g-dropout) as derived and maintained in the mean-variance mapping table 120 is as follows:

g-dropout: [μₒᵤₜ=u(1−p); vₒᵤₜ=v(1−p)] where μᵢₙ=u and vᵢₙ=v, and p is the percentage of inputs set to zero by the dropout layer.

At step 210, if a weight parameter (θ) is associated with layer (L), a weight initialization technique is evaluated for setting the weight parameter (θ) using a mean-variance mapping function (g-layer) for the layer (L) and the mean and variance of the input signal to the layer (L). In an embodiment of the present invention, a weight initialization technique is evaluated for setting the initial value of the weight parameter (θ) associated with the input signal of layer (L), such that the mean of the output signal of layer (L) is zero and the variance is 1 after applying a mean-variance mapping function for the layer (L). In operation, a mean-variance mapping function (g-layer) for layer (L) is derived using analytics based on the weight parameter (θ) and the type of layer (L) and/or activation function associated with the layer (L). In another embodiment of the present invention, a mean-variance mapping function (g-layer) for layer (L) is selected from the mean-variance mapping table based on the type of layer (L) and/or activation function associated with the layer (L). Further, the mean and variance of the input signal (μᵢₙ, vᵢₙ) of layer (L) is computed. As already described above, the mean and variance of the input signal of layer (L) is same as the mean and variance of the output signal of layer (L−1) or any preceding layer directly providing input to said layer (L). Yet further, the mean and variance of the input signal of layer (L) (μᵢₙ, vᵢₙ) are incorporated into derived/selected mean-variance mapping function (g-layer) for layer (L), and the mean of the output signal of layer (L) (μ_{Out}) is set to zero and the variance (vₒᵤₜ) is set to 1 after applying the computed mean-variance mapping function for layer (L).

g-layer, θ(μᵢₙ, vᵢₙ)=(0,1)

In accordance with various embodiments of the present invention, a weight initialization technique is evaluated for setting the initial value of weight parameter (θ) associated with the layer (L). The evaluation of a weight initialization technique includes evaluating a distribution for the weight parameter (θ) and ascertaining a sampling range for the weight parameter (θ). Further, the initial values of weight parameter (θ) of the layer (L) are selected from the ascertained range such that the mean of the output signal of layer (L) (μ_{Out}) is zero and the variance (vₒᵤₜ) is 1. In an exemplary embodiment of the present invention, the weight distribution may be selected from a normal distribution, uniform distribution or any other distribution.

At step 212, move to next layer and repeat step 206 to step 212 until L=output layer.

### EXAMPLE

In an example with reference to FIG. 1A, an input dataset (x) enters the input layer (L=1). The output of the input layer (L=1) is the input of the layer A (L=2). The mean μᵢₙ and variance vᵢₙ of the input dataset (x) of the input layer are E(x) and Var(x), respectively. Subsequent to passing through the input layer (L=1), the output is y, and the output signal has a mean μ_{Out}=E(y) and variance vₒᵤₜ=var(y). The dataset x is centered and normalized, such that the output signal of the input layer has a μ_{Out}=zero and vₒᵤₜ=1. Alternatively, if the data distribution is known and has mean u_data and variance v_data, this can be used to compute μ_{Out} and vₒᵤₜ. The input layer does not do anything and has no weights; it is only used to connect the neural network to the dataset. In the example, it is determined that Layer A and Layer C have weights that require initialization, but Layer B does not have weights, and does not require weight initialization.

For Layer A, the mean-variance mapping function (g-layer) is derived. Further, it can be observed that the output signal of the input layer is the input signal for layer A, therefore input mean and variance are μᵢₙ=E(y), vᵢₙ=var(y). Finally, the weight parameter (θ) for layer A is initialized, such that output mean=0 and variance=1 after incorporating μᵢₙ=E(y), vᵢₙ=var(y) in the derived mean-variance mapping function (g-layer).

For Layer C, weight initialization is required, however, the mean and variance of the input signal to Layer C is unknown. The mean and variance of the input signal to Layer C is same as the mean and variance of the output signal of layer B. Therefore, the mean and variance of the output signal of layer B are computed.

For Layer B, the input mean and variance is known (which is the same as the output mean and variance from Layer A) i.e. 0,1. Further, the mean-variance mapping function (g-layer) for layer B is derived. The output mean and variance of Layer B (which will be passed as the input mean and variance for Layer C) is computed by incorporating the input mean and variance (0,1) for layer B into the function (g-layer). Assuming the output of Layer B has mean=u and variance=v,

For layer C, the incoming signal has mean=u and variance=v (which is the output mean and variance from Layer B). The mean-variance mapping function (g-layer) for layer C is derived. Further, a weight initialization technique is evaluated to set initial values of weight parameter (θ) of Layer C, such that the output signal of Layer C has mean=0 and variance=1.

The preserving of mean and variance of the output signal to zero and one, respectively across each of the layers (L) that require weight initialization, ensures that that weight parameter (θ) is initialized properly, thereby eliminating the problem of exploding and/or vanishing output signals.

Advantageously, the method of the present invention, affords a technical effect in the field of artificial intelligence by improving deep learning of neural network models by automatically providing weight initialization techniques that adapt to a plurality of different and unique neural network architectures. Further, the method of the present invention solves the problem of exploding and vanishing output signals by analytically tracking the mean and variance of incoming signals as they propagate through the network, and appropriately scaling the weights at each layer. Furthermore, the method of the present invention affords improved performance of various multilayer perceptron, convolutional networks, and residual networks across a range of activation functions, dropout, weight decay, learning rate, normalizer, and optimizer settings. Yet further, the method of the present invention improves performance in vision, language, tabular, multi-task, and transfer learning scenarios associated with neural architecture search and activation function meta-learning. Yet further, the method of the present invention serves as an automatic configuration tool that makes design of new neural network architectures more robust.

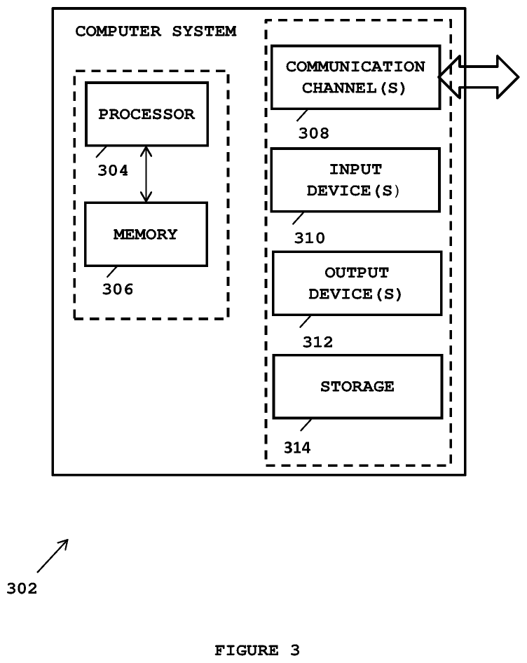

FIG. 3 illustrates an exemplary computer system in which various embodiments of the present invention may be implemented.

The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A method for evaluating weight initialization technique for individual layers of neural network models to analytically preserve mean and variance across layers, wherein the method is implemented by a processor executing program instructions stored in a memory, the method comprising:
deriving, by the processor, a mean-variance mapping function (g-layer) corresponding to respective layers of a neural network comprising a plurality of layers;
determining, by the processor, association of a weight parameter (θ) with the respective layers of the neural network; and
evaluating, by the processor, a weight initialization technique for selecting an initial value of respective weight parameter (θ) associated with each layer determined to have associated weight parameter (θ) out of the plurality of layers based on the derived mean-variance mapping function (g-layer) corresponding to said each layer, such that a mean (μ_{Out}) and a variance (vₒᵤₜ) of respective output signals of said each layer is zero and one, respectively.

2. The method as claimed in claim 1, wherein the derived mean-variance mapping functions (g-layer) mapped to corresponding layers of the neural network are stored in a mean-variance mapping table.

3. The method as claimed in claim 1, wherein the mean-variance mapping functions (g-layer) corresponding to the respective layers of the neural network are derived using data analytics based on any one of the following: a weight parameter associated with the respective layer, a type of said respective layer, an activation function associated with said respective layer or any combination thereof.

4. The method as claimed in claim 1, wherein the mean-variance mapping function (g-layer) corresponding to any layer of the neural network having no associated weight parameter (θ) is representative of a function derived to map a mean and a variance of input signal of the any layer with a mean and a variance of output signal after propagation through said any layer.

5. The method as claimed in claim 1, wherein the mean-variance mapping function (g-layer) corresponding to any layer of the neural network having an associated weight parameter (θ6) is representative of a function derived to map a mean and a variance of an input signal of the any layer and the weight parameter (θ) associated with said any layer with a mean and a variance of an output signal after propagation through said any layer.

6. The method as claimed in claim 1, wherein the neural network is an untrained neural network, further wherein each layer of the neural network is connected with its next layer or any subsequent layer of said neural network, such that an output of any layer (L) of said neural network is an input of its next layer (L+1) or a subsequent layer connected directly to said any layer (L), and a mean (μ_{Out}) and a variance (vₒᵤₜ)of an output signal of said any layer (L) is a mean (μᵢₙ) and a variance (vᵢₙ) of an input signal of the next layer (L+1) or the subsequent layer.

7. The method as claimed in claim 1, wherein the step of determining association of the weight parameter (θ) with the respective layers of the neural network comprises: identifying a type of the layer based on analysis of the layer; and determining association of weight parameter (θ) with the layer based on the identified type of the layer by accessing a predefined database, said predefined database comprising information associated with types of layers having weights and not having weights.

8. The method as claimed in claim 1, wherein the evaluating of the weight initialization technique for selecting the initial value of the respective weight parameter (θ) associated with the each layer determined to have associated weight parameter (θ) comprises:
a. computing and incorporating a mean (μᵢₙ) and a variance (vᵢₙ) of an input signal of a layer (L) out of the each layer determined to have associated weight parameter (θ) in the derived mean-variance mapping function (g-layer) corresponding to the layer (L), wherein the derived mean-variance mapping function maps the mean (μᵢₙ) and the variance (vᵢₙ) and the weight parameter (θ) associated with said layer (L) with a mean (μ_{Out}) and a variance (vₒᵤₜ) of an output signal after propagation through said layer (L);
b. evaluating a weight distribution for the weight parameter (θ) associated with the layer (L) and ascertaining a sampling range for said weight parameter (θ);
c. selecting the initial value of the weight parameter (θ) from the ascertained sampling range such that the mean (μ_{Out}) and variance (vₒᵤₜ) of the output signal of said layer (L) is zero and one, respectively on incorporating the selected initial value in said derived mean-variance mapping function (g-layer); and
d. repeating a-c for the each layer determined to have associated weight parameter (θ).

9. The method as claimed in claim 8, wherein the mean (μᵢₙ) and the variance (vᵢₙ) of the input signal of the layer (L) is same as a mean (μ_{Out}) and a variance (vₒᵤₜ) of an output signal of any preceding layer of the neural network directly providing input to said layer (L).

10. The method as claimed in claim 9, wherein the mean (μ_{Out}) and the variance (vₒᵤₜ) of the output signal of the any preceding layer is computed using a mean-variance mapping function (g-layer) corresponding to said any preceding layer if no weight parameter (θ) is associated with said any preceding layer; or the mean (μ_{Out}) and the variance (vₒᵤₜ) of the output signal of the any preceding layer is zero and one respectively, if said any preceding layer has an associated weight parameter (θ).

11. The method as claimed in claim 1, wherein a mean and a variance of an output signal of any layer of the neural network having no associated weight parameter (θ) is computed using the derived mean-variance mapping function (g-layer) corresponding to said any layer by:
computing a mean and a variance of the input signal of said any layer, wherein the mean and the variance of the input signal of said any layer is same as a mean and a variance of an output signal of any preceding layer of the neural network directly providing input to said any layer; and
incorporating the computed mean and the variance of the input signal of said any layer in the derived mean-variance mapping function (g-layer) to compute the mean and variance of the output signal after propagating through said any layer.

12. The method as claimed in claim 8, wherein the mean and the variance of the input signal of the layer (L) is computed by aggregation of input data if the layer (L) is an input layer.

13. A system for evaluating weight initialization technique for individual layers of neural network models to analytically preserve mean and variance across layers, the system comprising:
a memory storing program instructions; a processor configured to execute program instructions stored in the memory; and a weight initialization engine executed by the processor, and configured to:
derive a mean-variance mapping function (g-layer) corresponding to respective layers of a neural network comprising a plurality of layers;
determine association of a weight parameter (θ) with the respective layers of the neural network; and
evaluate a weight initialization technique for selecting an initial value of respective weight parameter (θ) associated with each layer determined to have associated weight parameter (θ) out of the plurality of layers based on the derived mean-variance mapping function (g-layer) corresponding to said each layer, such that a mean (μ_{Out}) and a variance (vₒᵤₜ) of respective output signals of said each layer is zero and one, respectively.

14. The system as claimed in claim 13, wherein the weight initialization engine comprises an interface unit executed by the processor, said interface unit configured to facilitate user interaction, and receive the neural network model.

15. The system as claimed in claim 13, wherein the weight initialization engine comprises a computation unit executed by the processor, said computation unit configured to store the derived mean-variance mapping functions (g-layer) mapped to corresponding layers of the neural network in a mean-variance mapping table.

16. The system as claimed in claim 13, wherein the mean-variance mapping functions (g-layer) corresponding to the respective layers of the neural network are derived using data analytics based on any one of the following: a weight parameter associated with the respective layer, a type of said respective layer, an activation function associated with said respective layer or any combination thereof.

17. The system as claimed in claim 13, wherein the mean-variance mapping function (g-layer) corresponding to any layer of the neural network having no associated weight parameter (θ) is representative of a function derived to map a mean and a variance of input signal of the any layer with a mean and a variance of output signal after propagation through said any layer.

18. The system as claimed in claim 13, wherein the mean-variance mapping function (g-layer) corresponding to any layer of the neural network having an associated weight parameter (θ) is representative of a function derived to map a mean and a variance of an input signal of the any layer and the weight parameter (θ) associated with said any layer with a mean and a variance of an output signal after propagation through said any layer.

19. The system as claimed in claim 13, wherein the neural network is an untrained neural network, further wherein each layer of the neural network is connected with its next layer or any subsequent layer of said neural network, such that an output of any layer (L) of said neural network is an input of its next layer (L+1) or a subsequent layer connected directly to said any layer (L), and a mean (μ_{Out}) and a variance (vₒᵤₜ) of an output signal of said any layer (L) is a mean (μᵢₙ) and a variance (vᵢₙ) of an input signal of the next layer (L+1) or the subsequent layer.

20. The system as claimed in claim 13, wherein the step of determining association of the weight parameter (θ) with the respective layers of the neural network comprises: identifying a type of the layer based on analysis of the layer; and determining association of weight parameter (θ) with the layer based on the identified type of the layer by accessing a predefined database, said predefined database comprising information associated with types of layers having weights and not having weights.

21. The system as claimed in claim 13, wherein the evaluating of the weight initialization technique for selecting the initial value of the respective weight parameter (θ) associated with the each layer determined to have associated weight parameter (θ) comprises:
a. computing and incorporating a mean (μᵢₙ) and a variance (vᵢₙ) of an input signal of a layer (L) out of the each layer determined to have associated weight parameter (θ) in the derived mean-variance mapping function (g- layer) corresponding to the layer (L), wherein the derived mean-variance mapping function maps the mean (μᵢₙ) and the variance (vᵢₙ) and the weight parameter (θ) associated with said layer (L) with a mean (μ_{Out}) and a variance (vₒᵤₜ) of an output signal after propagation through said layer (L);
b. evaluating a weight distribution for the weight parameter (θ) associated with the layer (L) and ascertaining a sampling range for said weight parameter (θ);
c. selecting the initial value of the weight parameter (θ) from the ascertained sampling range such that the mean (μ_{Out}) and variance (vₒᵤₜ) of the output signal of said layer (L) is zero and one, respectively on incorporating the selected initial value in said derived mean-variance mapping function (g-layer); and
d. repeating a-c for the each layer determined to have associated weight parameter (θ).

22. The system as claimed in claim 21, wherein the mean (μᵢₙ) and the variance (vᵢₙ) of the input signal of the layer (L) is same as a mean (μ_{Out}) and a variance (vₒᵤₜ) of an output signal of any preceding layer of the neural network directly providing input to said layer (L), further wherein the mean (μ_{Out}) and the variance (vₒᵤₜ) of the output signal of the any preceding layer is computed using a mean-variance mapping function (g-layer) corresponding to said any preceding layer if no weight parameter (θ) is associated with said any preceding layer; or the mean (μ_{Out}) and the variance (vₒᵤₜ) of the output signal of the any preceding layer is zero and one respectively, if said any preceding layer has an associated weight parameter (θ).

23. The system as claimed in claim 13, wherein a mean and a variance of an output signal of any layer of the neural network having no associated weight parameter (θ) is computed using the derived mean-variance mapping function (g-layer) corresponding to said any layer by:
computing a mean and a variance of the input signal of said any layer, wherein the mean and the variance of the input signal of said any layer is same as a mean and a variance of an output signal of any preceding layer of the neural network directly providing input to said any layer; and
incorporating the computed mean and the variance of the input signal of said any layer in the derived mean-variance mapping function (g-layer) to compute the mean and variance of the output signal after propagating through said any layer.

24. The system as claimed in claim 21, wherein the mean and the variance of the input signal of the layer (L) is computed by aggregation of input data if the layer (L) is an input layer.

25. A computer program product comprising:
a non-transitory computer-readable medium having computer-readable program code stored thereon, the computer-readable program code comprising instructions that, when executed by a processor, cause the processor to:
derive a mean-variance mapping function (g-layer) corresponding to respective layers of a neural network comprising a plurality of layers;
determine association of a weight parameter (θ) with the respective layers of the neural network; and
evaluate a weight initialization technique for selecting an initial value of respective weight parameter (θ) associated with each layer determined to have associated weight parameter (θ) out of the plurality of layers based on the derived mean-variance mapping function (g-layer) corresponding to said each layer, such that a mean (μ_{Out}) and a variance (vₒᵤₜ) of respective output signals of said each layer is zero and one, respectively.
